(19) United States
(12) Patent Application Publication
(10) Pub. No.: US 2004/0117918 A1
(43) Pub. Date: Jun. 24, 2004

(54) Fluorine-containing solvents and compositions and methods employing same

(75) Inventors: William Michael Scheper, Guilford, IN (US); Mark Robert Sivik, Mason, OH (US); Jichun Shi, Liberty Twp., OH (US); John Christian Haught, West Chester, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/714,783

(22) Filed: Nov. 17, 2003

Related U.S. Application Data
(60) Provisional application No. 60/432,436, filed on Dec. 11, 2002.

(51) Int. Cl. C11D 17/00

(52) U.S. Cl. 8/115.51; 510/412

(57) ABSTRACT

Fluorine-containing solvents and fabric article treating compositions and fabric article treating methods employing such solvents are provided.

### CROSS REFERENCE TO RELATED APPLICATIONS

This application claims priority under 35 U.S.C. §119(e) from Provisional Application Serial No. 60/432,436, filed on Dec. 11, 2002.

### FIELD OF THE INVENTION

The present invention relates to fabric article treating compositions comprising fluorine-containing solvents and fabric article treating methods employing such fluorine-containing solvents.

### BACKGROUND OF THE INVENTION

Solvents are essential ingredients in various compositions and processes used in fabric article cleaning and/or treatments. For example, dry cleaners use various types of solvents to treat fabric articles. However, the dry cleaners need to take precautions to mitigate the negatives associated with such solvents to the best of their ability.

The negatives associated with conventional solvents may include one or more of the following. The solvents may be flammable. The solvents may have too low of an oil solvency as measured by KB value. The solvents may have too high of a vapor pressure and/or too low of a vapor pressure. The solvents may have too low of a boiling point. The solvents may have a density that is too low. The solvents may raise environmental issues (e.g., possibility of global warming potential). All of these possible negatives make using conventional solvents very problematic and costly.

Accordingly, there is a need for a solvent that does not exhibit the negatives of the conventional dry cleaning solvents. There is also a need for compositions and/or methods employing such solvent.

### SUMMARY OF THE INVENTION

In one aspect of the present invention, the present invention relates to a fabric article treating composition comprising a fluorine-containing solvent which has at least one of the following properties:

1) an oil solvency as measured by KB value of greater than about 30;

2) non-flammable and has an oil solvency as measured by KB value of greater than about 9; or

3) a global warming potential of less than about 50; and

an adjunct ingredient.

In another aspect of the present invention, a method for treating a fabric article in need of treatment comprising the step of contacting the fabric article with a fluorine-containing solvent according to the present invention such that the fabric article is treated, is provided.

In yet another aspect of the present invention, a fabric article treating composition comprising a fluorine-containing solvent having an oil solvency as measured by KB value of greater than about 30 and an adjunct ingredient, is provided.

In still another aspect of the present invention, a fabric article treating composition comprising a fluorine-containing solvent that is non-flammable and has an oil solvency as measured by KB value of greater than about 9 and an adjunct ingredient, is provided.

In yet another aspect of the present invention, a fabric article treating composition comprising a fluorine-containing solvent having a global warming potential of less than about 50 and an adjunct ingredient, is provided.

### DETAILED DESCRIPTION OF THE INVENTION

Definitions

The term “fabric article” means any article that is customarily cleaned in a conventional laundry process or in a dry cleaning process. As such, the term encompasses articles of clothing, linens, drapery, and clothing accessories. The term also encompasses other items made in whole or in part of fabric, such as tote bags, furniture covers, tarpaulins and the like.

The term “soil” means any undesirable substance on a fabric article that the target for removal by the fabric article treatment process. By the terms “water-based” or “hydrophilic” soils means that the soil comprises water at the time it comes in contact with the fabric article, or the soil retains a significant portion of water on the fabric article. Examples of water-based soils include, but are not limited to, beverages, many food soils, water soluble dyes, bodily fluids such as sweat, urine or blood, outdoor soils such as grass stains and mud.

The term “fabric article treating composition” refer to the wash fluid that that comes into direct contact with fabric articles to be cleaned. It should be understood that the term “fabric article treating composition” encompasses uses other than cleaning, such as refreshing, conditioning and sizing. In a typical embodiment, the fabric article treating composition comprises the fluorine-containing solvent(s) and optionally, adjunct ingredients and/or polar solvents, which are described in more detail hereinbelow.

The term “detergent composition” refers to any detersive composition comprising cleaning or detersive adjuncts, such as surfactants, enzymes, bleaches or the like, that when mixed with a fluorine-containing solvent, results in a fabric article treating composition of the present invention.

The term “mixing” means combining two or more materials (specifically, a detergent composition and a fluorine-containing solvent) in such a way that a homogeneous mixture or stable dispersion or suspension is formed. Suitable mixing processes are known in the art. Nonlimiting examples of suitable mixing processes include vortex mixing processes and static mixing processes.

The term “non-immersive” as used herein means that essentially all of the fluid is in intimate contact with the fabric articles. There is at most minimal amounts of “free” wash liquor. It is unlike an “immersive” process where the washing fluid is a bath in which the fabric articles are submerged. “immersive” as used herein, it is meant that some free standing, excess (above the dry weight of the fabric articles) solvents are in contact with the fabric articles being treated by the processes of the present invention. A process is non-immersive if the fluid absorbed by the fabric specimen is less than about 0.8 of the dry weight of the fabric specimen.

“Average molecular weight” as used herein means the weight-average molecular weight of a polymer, as determined by gel permeation chromatography.

Fluorine-Containing Solvents

Fluorine-containing solvents suitable for use in the present invention may exhibit one or more of the following properties:

a) a global warming potential of less than about 50;

b) an oil solvency as measured by KB value of greater than 10;

c) a density of greater than about 1.1 g/ml;

d) a boiling point of greater than about 35° C.;

e) mole percent of fluorine atoms is greater than mole percent of hydrogen atoms; and

f) a vapor pressure in the range of less than about 0.1 mm Hg as determined at 25° C.

The “global warming potential” (GWP) is a quantified measure of the global averages relative radiative forcing impacts of a particular greenhouse gas. It is defined as the cumulative radiative forcing, both direct and indirect, integrated over a period of time from the emission of a unit mass (e.g., 1 kg) of a gas being tested relative to that of a reference gas (e.g., carbon dioxide). Direct radiative forcing occurs when the gas being test is a greenhouse gas. Indirect radiative forcing occurs when chemical transformations involving the original gas produce a gas or gasses that are greenhouse gases, or when a gas influences other radiatively important processes, such as the atmospheric lifetimes of other gases. A standard methodology for estimating GWPs for greenhouse gases can be found in “Greenhouse Gases And Global Warming Potential Values”, an excerpt from U.S. Environmental Protection Agency Publication No. EPA 430-R-02-003, in Third Assessment Report of The Intergovernmental Panel on Climate Change (IPPC 2001, published by Cambridge University Press). The solvents of the present invention exhibit a global warming potential of less than about 50, preferably less than about 35, and more preferably less than about 20.

As used herein, the term “oil solvency” means the ability of a solvent to dissolve an oily substance. In the dry cleaning industry, it is typically measured by the Kauri Butanol. value (KB value). The measurement method and KB values of common dry cleaning solvents are well known to those skilled in the art and can be found in standard references (Kirk-Othmer Encyclopedia of Chemical Technology, 4^{th} ed., vol. 22, pp. 529-571). The KB can also be determined by a standard test method ASTM B 1133. The solvents of the present invention exhibit an oil solvency, as measured by KB value, of greater than 10, preferably greater than 15, more preferably greater than 20, even more preferably greater than 30, and most preferably greater than 35, up to the solvency of Kauri resin in butanol.

As used herein, the term “vapor pressure” means the pressure of a substance above it's pure liquid at room temperature (about 25° C.) and is measured by standard analytical methods (OECD Method 104 or CARB Method 310), wherein “OECD” refers to the Organization for Economic Co-operation and Development and “CARB” refers to the California Air Resources Board. The solvents of the present invention exhibit a vapor pressure at 25° C. of from about 0.3 mm Hg to about 30 mm Hg , preferably from about 0.4 mm Hg to about 25 mm Hg, and more preferably from about 0.5 mm Hg to about 20 mm Hg.

As used herein, the term “density” means the mass of a substance divided by its volume and is measured by standard analytical methods (OECD Method 109). The solvents of the present invention exhibit a density of greater than 1.1 g/ml, preferably greater than 1.2 g/ml, and more preferably greater than 1.3 g/ml.

Further, the solvent is preferably non-flammable. The term “non-flammable” as used herein means that a material, particularly a solvent, that has a flash point of greater than about 200° F. (93.3° C.), as measured by the Pensky-Martens Closed Cup Tester (ASTM D-93).

In some embodiments, the solvents of the present invention may interact the fabric article and/or fibers within the fabric article. Further, the solvents may be swellable with respect to the fabric article. In other embodiments, the solvents may be oleophilic.

The solvents of the present invention exhibit a boiling point of greater than about 35° C., preferably greater than about 40° C. and more preferably greater than about 50° C.

The solvents of the present invention comprise one or more fluorine atoms.

In one embodiment, the mole percent of fluorine atoms is greater than the mole percent of hydrogen atoms. In other words, the mole ratio of fluorine atom to hydrogen atoms is at greater than 1:1, preferably greater than 1.1:1 and more preferably greater than 1.5:1.

In another embodiment, the mole ratio of fluorine to hydrogen in the solvent is in the range of from about 10:1 to about 1:10, preferably from about 5:1 to about 1:5 and more preferably from about 2:1 to about 1:2.

The solvents of the present invention may be selected from the group consisting of: fluoroamines, fluoroethers, fluoroalcohols, hydrofluoroethers, fluorosilicones and mixtures thereof.

The solvents of the present invention may have the formula:

CF₃(CF₂)ₙOX or CF₃(CF₂)ₙNX′X

wherein n is an integer of from about 2 to about 20, and X, X′ contains at least one hydrogen.

In one embodiment, X, X′ are moieties that contain at least one hydrogen and one fluorine. In another embodiment, X, X′ are idependently selected from the group consisting of: alkyl, alkylene, cycloalkyl, aryl, oxygen-containing group and mixtures thereof.

In still another embodiment, at least one of the X, X′ moieties has the formula:

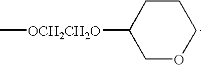

In yet another embodiment, at least one of the X, X′ moieties has the formula:

—(CH₂)ₘO(CH₂)ₚCH₃

wherein m is from about 3 to about 20 and p is from about 2 to about 20.

A nonlimiting example of a suitable Fluorine-containing solvent can be made by the following process.

Preparation of C₄F₉O-pyranyl Acetal

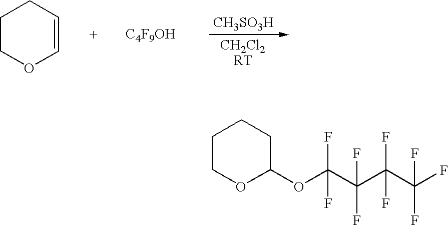

Nonafluorobutanol (28.99 g, 97.9 mmol) is placed into a 1000 ml three-necked round-bottomed flask, fitted with a heating mantle, magnetic stirrer, internal thermometer and argon inlet and dried under vacuum at 75° C. After cooling to ambient and releasing the vacuum with argon, methylene chloride (500 ml), 3,4-dihydro-2H-pyran (24.71 g, 293.7 mmol) and methanesulfonic acid (0.94 g, 9.8 mmol) are added. The mixture is stirred 18 h at ambient and washed twice with saturated sodium bicarbonate. The organic layer is dried with magnesium sulfate, concentrated by rotary evaporation and further dried under vacuum.

Fabric Article Treating Composition

The fabric article treating composition of the present invention comprises a fluorine-containing solvent, and optionally, an adjunct ingredient which is a polar solvent, an additive, or mixtures thereof.

Suitable additives include, but are not limited to, builders, surfactants, enzymes, bleach activators, bleach catalysts, bleach boosters, bleaches, alkalinity sources, antibacterial agents, colorants, perfumes, pro-perfumes, finishing aids, lime soap dispersants, odor control agents, odor neutralizers, polymeric dye transfer inhibiting agents, crystal growth inhibitors, photobleaches, heavy metal ion sequestrants, anti-tarnishing agents, anti-microbial agents, anti-oxidants, anti-redeposition agents, soil release polymers, electrolytes, pH modifiers, thickeners, abrasives, divalent or trivalent ions, metal ion salts, enzyme stabilizers, corrosion inhibitors, polyamines and/or their alkoxylates, suds stabilizing polymers, solvents, process aids, fabric softening agents, optical brighteners, hydrotropes, suds or foam suppressors, suds or foam boosters, and mixtures thereof.

The level of fluorine-containing solvent in the fabric article treating compositions of the present invention is preferably from about 70% to about 99.99%, more preferably from about 90% to about 99.9%, and even more preferably from about 95% to about 99.8% by weight of the fabric article treating composition.

The fluorine-containing solvent may also be present in the detergent composition. The level of fluorine-containing solvent, when present in the detergent compositions, is preferably from about 0.1% to about 80%, more preferably from about 0.5% to about 60%, and even more preferably from about 1% to about 50% by weight of the detergent composition.

In a specific embodiment suitable for cleaning fabric articles, the fabric article treatment composition is a mixture comprising one or more fluorine-containing solvents and a detergent composition, which contains adjuncts having cleaning or detersive capabilities, such as surfactants, bleaches, enzymes and the like.

In another embodiment suitable for finishing fabric articles, the fabric article treatment composition is a mixture comprising one or more fluorine-containing solvents and a detergent composition, which contains adjuncts having fabric softening and/or refreshing capabilities, such as softeners, perfumes, and the like.

Polar Solvents

Compositions according to the present invention may further comprise a polar solvent. Non-limiting examples of polar solvents include: water, alcohols, glycols, polyglycols, ethers, glycol ethers, carbonates, dibasic esters, ketones, other oxygenated solvents, and mixtures thereof. Further examples of alcohols include: linear or branched, saturated or unsaturated, aliphatic or aromatic C1-C16 alcohols, such as propanol, ethanol, isopropyl alcohol, benzyl alcohol, and the like, and diols, such as 1,2-hexanediol. Exemplary glycols and polyglycols useful in the present invention include the Dowanol® series by Dow, such as Dow Chemical, such as Dowanol® TPM, TPnP, DPnB, DPnP, TPnB, PPh, DPM, DPMA, DB, and others. Further examples include propylene glycol, butylene glycol, polybutylene glycol and more hydrophobic glycols. Exemplary carbonate solvents are ethylene, propylene and butylene carbonates, such as those available under the Jeffsol® tradename (available from Huntsman Chemicals).

Polar solvents suitable for use in the present invention can be further identified through their Hansen solubility parameters, including their dispersive force (D), polarity (P) and hydrogen bonding (H). Preferred polar solvents or polar solvent mixtures have fractional polarity (f_{P}) and fractional hydrogen bonding (f_{H}) values of f_{P}>0.02 and f_{H}>0.10, where f_{P}=P/(D+P+H) and f_{H}=H/(D+P+H), more preferably f_{P}>0.05 and f_{H}>0.20, and most preferably f_{P}>0.07 and f_{H}>0.30.

When present in the detergent composition of the present invention, the levels of polar solvent can be from about 0.001 to about 70%, preferably 1 to 50%, even more preferably 1 to 30% by weight of the detergent composition. When present in the wash fluid (i.e., the fabric article treating composition) of the present invention, the polar solvent typically comprise from about 0.001% to about 10%, preferably from about 0.005% to about 5%, more preferably from about 0.01% to about 1% by weight of the wash fluid/fabric article treating composition.

Further, in some embodiments, the optionally polar solvent is water. When present in the wash fluid (i.e., the fabric article treating composition) of the present invention, water typically comprise from about 0.001% to about 10%, preferably from about 0.005% to about 5%, more preferably from about 0.01% to about 1% by weight of the wash fluid/fabric article treating composition.

When present in the detergent compositions of the present invention, water typically comprises from about 1% to about 90%, preferably from about 2% to about 75%, more preferably from about 5% to about 40% by weight of the detergent composition.

Additives or Fabric Treatment Adjuncts

The compositions of the present invention may optionally further comprise one or more additives. The amount of the additives in the composition may vary, depending on the particular additive present. In any event, any additive must be suitable for use in combination with a fluorine-containing solvent in accordance with the present invention.

Typically, when present in the fabric article treating compositions of the present invention, the additive preferably comprises from about 0.01% to about 10%, more preferably from about 0.02% to about 5%, even more preferably from about 0.05% to about 2% by weight of the fabric article treating composition.

Also typically, when present in the detergent compositions of the present invention, the additive preferably comprises from about 1% to about 90%, more preferably from about 2% to about 75%, even more preferably from about 5% to about 60% by weight of the detergent composition.

Further, in some embodiments, detersive enzymes, such as proteases, amylases, cellulases, lipases and the like, as well as bleach catalysts, including the macrocyclic types having manganese or similar transition metals, can be used herein at very low levels, typically less than about 5%, more typically less than about 1%, and even more typically less than about 0.1%, by weight of the detergent composition.

Additives that are catalytic, for example enzymes, can be used in “forward” or “reverse” modes. For example, a lipolase or other hydrolase may be used, optionally in the presence of alcohols as adjuncts, to convert fatty acids to esters, thereby increasing their solubility in the solvent. This is a “reverse” operation. In contrast, the normal use of this hydrolase in water is to convert a less water-soluble fatty ester to a more water-soluble material.

Some of the suitable additives preferably comprise a strongly polar and/or hydrogen-bonding head group, which may further enhances soil removal by the compositions of the present invention. Examples of the strongly polar and/or hydrogen-bonding head group-containing materials include, but are not limited to, alcohols, cationic materials, such as cationic surfactants, quaternary surfactants, quaternary ammonium salts, such as ammonium chlorides (nonlimiting examples of ammonium chlorides are Arquad® materials commercially available from Akzo Nobel) and cationic fabric softening actives, nonionic materials such as nonionic surfactants (i.e., alcohol ethoxylates, polyhydroxy fatty acid amides), gemini surfactants, anionic surfactants, zwitterionic surfactants, carboxylic acids, sulfates, sulphonates, phosphates, phosphonates, and nitrogen containing materials.

Some of the commonly used additives are described in details below.

(i) Surfactants

The surfactant component of the present invention can be a material that is capable of suspending water in a fluorine-containing solvent and/or enhancing soil removal benefits of a fluorine-containing solvent. The surfactants may be soluble in the fluorine-containing solvent.

Nonlimiting examples of surfactants suitable for use in the present invention has the general formula:

Yᵤ-(Lₜ-Xᵥ)ₓ—Y′_{w} (I)

L_{y}-(Xᵥ—Yᵤ)_{x-L′}_{z} (II)

and mixtures thereof;

wherein L and L′ are solvent compatibilizing (or lipophilic) moieties, which are independently selected from:

(a) C1-C22 alkyl or C4-C12 alkoxy, linear or branched, cyclic or acyclic, saturated or unsaturated, substituted or unsubstituted;

(b) siloxanes having the formula:

MₐD_{b}D′_{c}D″_{d}

wherein a is 0-2; b is 0-1000; c is 0-50; d is 0-50, provided that a+c+d is at least 1;

M is R¹₃₋ₑXₑSiO_{1/2} wherein R¹ is independently H, or a monovalent hydrocarbon group, X is hydroxyl group, and e is 0 or 1;

D is R⁴₂SiO_{2/2} wherein R⁴ is independently H or a monovalent hydrocarbon group;

D′ is R⁵₂SiO_{2/2} wherein R⁵ is independently R² provided that at least one R⁵ is (CH₂)_{f}(C₆Q₄)_{g}O—(C₂H₄O)ₕ—(C₃H₆O)ᵢ(CₖH₂ₖ)ⱼ—R³, wherein R³ is independently H, a monovalent hydrocarbon group or an alkoxy group, f is 1-10, g is 0 or 1, h is 1-50, i is 0-50, j is 0-50, k is 4-8; C₆Q₄ is unsubstituted or substituted; Q is independently selected from H, C₁₋₁₀ alkyl, C₁₋₁₀ alkenyl, and mixtures thereof; and

D″ is R⁶₂SiO_{2/2} wherein R⁶ is independently H, a monovalent hydrocarbon group or (CH₂)₁(C₆Q₄)ₘ(A)ₙ[(L)ₒ-(A′)ₚ-]_{q}-(L′)ᵣZ(G)ₛ, wherein 1 is 1-10; m is 0 or 1; n is 0-5; o is 0-3; p is 0 or 1; q is 0-10; r is 0-3; s is 0-3; C₆Q₄ is unsubstituted or substituted; Q is independently a linking from H, C₁₋₁₀ alkyl, C₁₋₁₀ alkenyl, and mixtures thereof; A and A′ are each independently a linking moiety representing an ester, a keto, an ether, a thio, an amido, an amino, a C₁₋₄ fluoroalkyl, a C₁₋₄ fluoroalkenyl, a branched or straight chained polyalkylene oxide, a phosphate, a sulfonyl, a sulfate, an ammonium, and mixtures thereof; L and L′ are each independently a C₁₋₃₀ straight chained or branched alkyl or alkenyl or an aryl which is unsubstituted or substituted; Z is a hydrogen, carboxylic acid, a hydroxy, a phosphato, a phosphate ester, a sulfonyl, a sulfonate, a sulfate, a branched or straight-chained polyalkylene oxide, a nitryl, a glyceryl, an aryl unsubstituted or substituted with a C₁₋₃₀ alkyl or alkenyl, a carbohydrate unsubstituted or substituted with a C₁₋₁₀ alkyl or alkenyl or an ammonium; G is an anion or cation such as H⁺, Na⁺, Li⁺, K⁺, NH₄⁺, Ca⁺², Mg⁺², C⁻, Br⁻, I⁻, mesylate or tosylate; and D″ can be capped with C1-C4 alkyl or hydroxy groups;

Y and Y′ are hydrophilic moieties, which are independently selected from hydroxy; polyhydroxy; C1-C3 alkoxy; mono- or di- alkanolamine; C1-C4 alkyl substituted alkanolamine; substituted heterocyclic containing O, S, N; sulfates; carboxylate; carbonate; and when Y and/or Y′ is ethoxy (EO) or propoxy (PO), it must be capped with R, which is selected from the group consisting of:

(i) a 4 to 8 membered, substituted or unsubstituted, heterocyclic ring containing from 1 to 3 hetero atoms; and

(ii) linear or branched, saturated or unsaturated, substituted or unsubstituted, cyclic or acyclic, aliphatic or aromatic hydrocarbon radicals having from about 1 to about 30 carbon atoms;

X is a bridging linkage selected from O; S; N; P; C1 to C22 alkyl, linear or branched, saturated or unsaturated, substituted or unsubstituted, cyclic or acyclic, aliphatic or aromatic, interrupted by O, S, N, P; glycidyl, ester, amido, amino, PO₄²⁻, HPO₄⁻, PO₃²⁻, HPO₃⁻, which are protonated or unprotonated;

u and w are integers independently selected from 0 to 20, provided that u+w ≧1;

t is an integer from 1 to 10;

v is an integer from 0 to 10;

x is an integer from 1 to 20; and

y and z are integers independently selected from 1 to 10.

Nonlimiting examples of surfactants having the above formula include:

(1) alkanolamines;

(2) phophate/phosphonate esters;

(3) gemini surfactants including, but are not limited to, gemini diols, gemini amide alkoxylates, gemini amino alkoxylates;

(4) capped nonionic surfactants;

(5) capped silicone surfactants such as nonionic silicone ethoxylates, silicone amine derivatives;

(6) alkyl alkoxylates;

(7) polyol surfactants; and

mixtures thereof.

Examples of these surfactants are disclosed in U.S. patent applications Ser. No. 60/483,343 and 60/482,958, filed on Jun. 27, 2003.

Suitable nonionic surfactants may include, but are not limited to, the following:

a) Polyethylene oxide condensates of nonyl phenol and myristyl alcohol, such as in U.S. Pat. No. 4,685,930, issued to Kasprzak; and

b) fatty alcohol ethoxylates, R—(OCH₂CH₂)ₐOH a=1 to 100, typically 12-40, R=hydrocarbon residue 8 to 20 C atoms, typically linear alkyl. Examples polyoxyethylene lauryl ether, with 4 or 23 oxyethylene groups; polyoxyethylene cetyl ether with 2, 10 or 20 oxyethylene groups; polyoxyethylene stearyl ether, with 2, 10, 20, 21 or 100 oxyethylene groups; polyoxyethylene (2), (10) oleyl ether, with 2 or 10 oxyethylene groups.

Commercially available examples include, but are not limited to: ALFONIC, BRIJ, GENAPOL, NEODOL, SURFONIC, TRYCOL; additional examples are described in U.S. Pat. No. 6,013,683, issued to Hill et al.

Suitable cationic surfactants include, but are not limited to dialkyldimethylammonium salts having the formula:

R′R″N⁺(CH₃)₂X⁻

where each R′R″ is independently selected from the group consisting of 12-30 C atoms or derived from tallow, coconut oil or soy, X═Cl or Br, Examples include: didodecyldimethylammonium bromide (DDAB), dihexadecyldimethyl ammonium chloride, dihexadecyldimethyl ammonium bromide, dioctadecyldimethyl ammonium chloride, dieicosyldimethyl ammonium chloride, didocosyldimethyl ammonium chloride, dicoconutdimethyl ammonium chloride, ditallowdimethyl ammonium bromide (DTAB). Commercially available examples include, but are not limited to: ADOGEN, ARQUAD, TOMAH, VARIQUAT. Additional examples are described in U.S. Pat. No. 6,013,683, issued to Hill et al.

One class of surfactants suitable for use herein is siloxane-based surfactants. The siloxane-based surfactants typically have a weight-average molecular weight from 500 to 20,000. Such materials, derived from poly(dimethylsiloxane), are well known in the art. In the present invention, not all such siloxane-based surfactants are suitable, because they do not provide improved cleaning of soils compared to the level of cleaning provided by the fluorine-containing solvent itself.

Suitable siloxane-based surfactants comprise a polyether siloxane having the formula:

MₐD_{b}D′_{c}D″_{d}M′₂₋ₐ

wherein a is 0-2; b is 0-1000; c is 0-50; d is 0-50, provided that a+c+d is at least 1;

M is R¹₃₋ₑXₑSiO_{1/2} wherein R¹ is independently H, or a monovalent hydrocarbon group, X is hydroxyl group, and e is 0 or 1;

M′ is R²₃SiO_{1/2} wherein R² is independently H, a monovalent hydrocarbon group, or (CH₂)_{f}—(C6H4)_{g}O—(C₂H₄O)ₕ—(C₃H₆O)ᵢ—(CₖH₂ₖO)ⱼ—R³, provided that at least one R² is (CH₂)_{f}—(C6H4)_{g}O—(C₂H₄O)ₕ—(C₃H₆O)ᵢ—(CₖH₂ₖO)ⱼ—R³, wherein R³ is independently H, a monovalent hydrocarbon group or an alkoxy group, f is 1-10, g is 0 or 1, h is 1-50, i is 0-50, j is 0-50, k is 4-8;

D is R⁴₂SiO_{2/2} wherein R⁴ is independently H or a monovalent hydrocarbon group;

D′ is R⁵₂SiO_{2/2} wherein R⁵ is independently R² provided that at least one R⁵ is (CH₂)_{f}—(C₆Q₄)_{g}O—(C₂H₄O)ₕ—(C₃H₆O)ᵢ—(CₖH₂ₖO)ⱼ—R³, wherein R³ is independently H, a monovalent hydrocarbon group or an alkoxy group, f is 1-10, g is 0 or 1, h is 1-50, i is 0-50, j is 0-50, k is 4-8; and

D″ is R⁶₂SiO_{2/2} wherein R⁶ is independently H, a monovalent hydrocarbon group or (CH₂)ₗ(C₆H₄)ₘ(A)ₙ-[(L)_{O}-(A′)ₚ-]_{q}-(L′)ᵣZ(G)ₛ, wherein 1 is 1-10; m is 0 or 1; n is 0-5; o is 0-3; p is 0 or 1; q is 0-10; r is 0-3; s is 0-3;C₆Q₄ is unsubstituted or substituted with C₁₋₁₀ alkyl or C₁₋₁₀ alkenyl; Q is independently H, C₁₋₁₀ alkyl, C₁₋₁₀ alkenyl, or mixtures thereof; A and A′ are each independently a linking moiety representing an ester, a keto, an ether, a thio, an amido, an amino, a C₁₋₄ fluoroalkyl, a C₁₋₄ fluoroalkenyl, a branched or straight chained polyalkylene oxide, a phosphate, a sulfonyl, a sulfate, an ammonium, and mixtures thereof; L and L′ are each independently a C₁₋₃₀ straight chained or branched alkyl or alkenyl or an aryl which is unsubstituted or substituted; Z is a hydrogen, carboxylic acid, a hydroxy, a phosphato, a phosphate ester, a sulfonyl, a sulfonate, a sulfate, a branched or straight-chained polyalkylene oxide, a nitryl, a glyceryl, an aryl unsubstituted or substituted with a C₁₋₃₀ alkyl or alkenyl, a carbohydrate unsubstituted or substituted with a C₁₋₁₀ alkyl or alkenyl or an ammonium; G is an anion or cation such as H⁺, Na⁺, Li⁺, K⁺, NH₄⁺, Ca⁺², Mg⁺², Cl⁻, Br⁻, I⁻, mesylate or tosylate; D″ can be capped with C1-C4 alkyl or hydroxy groups;

Examples of the types of siloxane-based surfactants described herein above may be found in EP 1,043,443A1, EP 1,041,189A1 and WO 01/34,706 (all to GE Silicones) and U.S. Pat. No. 5,676,705, U.S. Pat. No. 5,683,977, U.S. Pat. No. 5,683,473, and EP1,092,803A1 (all to Lever Brothers).

Nonlimiting commercially available examples of suitable siloxane-based surfactants are TSF 4446 (by General Electric Silicones), XS69-B5476 (by General Electric Silicones); Jenamine HSX (by DelCon) and Y12147 (by OSi Specialties).

Another class of materials suitable for use herein as the surfactant component is organic-based surfactants. In some embodiments, the surfactants are organosulfosuccinate surfactants, with carbon chains of from about 6 to about 20 carbon atoms. In other embodiments, the surfactants are organosulfosuccinates containing dialkly chains, each with carbon chains of from about 6 to about 20 carbon atoms. In yet another embodiment, the organosulfosuccinate surfactants contain chains of aryl or alkyl aryl, substituted or unsubstituted, branched or linear, saturated or unsaturated groups.

Nonlimiting examples of suitable organosulfosuccinate surfactants are available under the tradenames of Aerosol® OT and Aerosol® TR-70 (by Cytec).

Nonlimiting examples of ethoxylated materials, such as ethoxylated surfactants include compounds having the general formula:

R⁸-Z-(CH₂CH₂O)ₛB

wherein R⁸ is an alkyl group or an alkyl aryl group, selected from the group consisting of primary, secondary and branched chain alkyl hydrocarbyl groups, primary, secondary and branched chain alkenyl hydrocarbyl groups, and/or primary, secondary and branched chain alkyl- and alkenyl-substituted phenolic hydrocarbyl groups having from about 6 to about 20 carbon atoms, preferably from about 8 to about 18, more preferably from about 10 to about 15 carbon atoms; s is an integer from about 2 to about 45, preferably from about 2 to about 20, more preferably from about 2 to about 12; B is a hydrogen, a carboxylate group, or a sulfate group; and linking group Z is —O—, —C(O)O—, —C(O)N(R)—, or —C(O)N(R)—, and mixtures thereof, in which R, when present, is R⁸ or hydrogen.

The nonionic surfactants herein are characterized by an HLB (hydrophilic-hydrophobic balance) of from 5 to 20, preferably from 6 to 15.

In some embodiments, the nonionic surfactants are alkyl ethoxylate surfactants with each R⁸ being C₈-C₁₆ straight chain and/or branch chain alkyl and the number of ethyleneoxy groups s being from about 2 to about 6, preferably from about 2 to about 4, more preferably with R⁸ being C₈-C₁₅ alkyl and s being from about 2.25 to about 3.5. These nonionic surfactants are characterized by an HLB of from 6 to about 11, preferably from about 6.5 to about 9.5, and more preferably from about 7 to about 9. Nonlimiting examples of commercially available alkyl ethoxylate surfactants are Neodol® 91-2.5 (C₉-C₁₀, s=2.7, HLB=8.5), Neodol® 23-3 (C₁₂-C₁₃, s=2.9, HLB=7.9) and Neodol® 25-3 (C₁₂-C₁₅, s=2.8, HLB=7.5). Neodol® available from Shell Chemicals.

Further nonlimiting examples include nonionic surfactants selected from the group consisting of fatty acid (C₁₂₋₁₈) esters of ethoxylated (EO₅₋₁₀₀) sorbitans. In some embodiments, the surfactant is selected from the group consisting of mixtures of laurate esters of sorbitol and sorbitol anhydrides; mixtures of stearate esters of sorbitol and sorbitol anhydrides; and mixtures of oleate esters of sorbitol and sorbitol anhydrides. In one specific embodiment, the surfactant is selected from the group consisting of Polysorbate® 20, which is a mixture of laurate esters of sorbitol and sorbitol anhydrides consisting predominantly of the monoester, condensed with about 20 moles of ethylene oxide. In another embodiment, the Polysorbate® 60 which is a mixture of stearate esters of sorbitol and sorbitol anhydride, consisting predominantly of the monoester, condensed with about 20 moles of ethylene oxide. In yet another embodiment, the Polysorbate® 80 which is a mixture of oleate esters of sorbitol and sorbitol anhydrides, consisting predominantly of the monoester, condensed with about 20 moles of ethylene oxide; and mixtures thereof.

Other examples of ethoxylated surfactant include carboxylated alcohol ethoxylate, also known as ether carboxylate, with R⁸ having from about 12 to about 16 carbon atoms and s being from about 5 to about 13; ethoxylated quaternary ammonium surfactants, such as PEG-5 cocomonium methosulfate, PEG-15 cocomonium chloride, PEG-15 oleammonium chloride and bis(polyethoxyethanol)tallow ammonium chloride.

Other suitable nonionic ethoxylated surfactants are ethoxylated alkyl amines derived from the condensation of ethylene oxide with hydrophobic alkyl amines, with R⁸ having from about 8 to about 22 carbon atoms and s being from about 3 to about 30.

Also suitable nonionic ethoxylated surfactants for use herein are alkylpolysaccharides which are disclosed in U.S. Pat. No. 4,565,647, Llenado, issued Jan. 21, 1986, having a hydrophobic group containing from about 8 to about 30 carbon atoms, preferably from about 10 to about 16 carbon atoms and a polysaccharide, e.g., a polyglycoside, hydrophilic group containing from about 1.3 to about 10, preferably from about 1.3 to about 3, most preferably from about 1.3 to about 2.7 saccharide units. Any reducing saccharide containing 5 or 6 carbon atoms can be used, e.g., glucose, galactose and galactosyl moieties can be substituted for the glucosyl moieties. The intersaccharide bonds can be, e.g., between the one position of the additional saccharide units and the 2-, 3-, 4-, and/or 6-positions on the preceding saccharide units. The preferred alkylpolyglycosides have the formula:

R²O(CₙH₂ₙO)t(glycosyl)ₓ

wherein R² is selected from the group consisting of alkyl, alkylphenyl, hydroxyalkyl, hydroxyalkylphenyl, and mixtures thereof in which the alkyl groups contain from 10 to 18, preferably from 12 to 14, carbon atoms; n is 2 or 3, preferably from about 1.3 to about 3, most preferably from about 1.3 to about 2.7. The glycosyl is preferably derived from glucose.

In one embodiment, the nonionic surfactants comprise polyhydroxy fatty acid amide surfactants of the formula:

R²—C(O)—N(R¹)-Z

wherein R¹ is H, or R¹ is C₁₋₄ hydrocarbyl, 2-hydroxy ethyl, 2-hydroxy propyl or a mixture thereof, R² is C₅₋₃₁ hydrocarbyl, and Z is a polyhydroxyhydrocarbyl having a linear hydrocarbyl chain with at least 3 hydroxyls directly connected to the chain, or an alkoxylated derivative thereof. Preferably, R¹ is methyl, R² is a straight C₁₁₋₁₅ alkyl or C₁₆₋₁₈ alkyl or alkenyl chain such as coconut alkyl or mixtures thereof, and Z is derived from a reducing sugar such as glucose, fructose, maltose, lactose, in a reductive amination reaction.

In another embodiment, the anionic surfactants include alkyl alkoxylated sulfate surfactants hereof are water soluble salts or acids of the formula RO(A)ₘSO3M wherein R is an unsubstituted C₁₀-C₂₄ alkyl or hydroxyalkyl group having a C₁₀-C₂₄ alkyl component, preferably a C₁₂-C₂₀ alkyl or hydroxyalkyl, more preferably C₁₂-C₁₈ alkyl or hydroxyalkyl, A is an ethoxy or propoxy unit, m is greater than zero, typically between about 0.5 and about 6, more preferably between about 0.5 and about 3, and M is H or a cation which can be, for example, a metal cation (e.g., sodium, potassium, lithium, calcium, magnesium, etc.), ammonium or substituted-ammonium cation. Alkyl ethoxylated sulfates as well as alkyl propoxylated sulfates are contemplated herein.

In yet another embodiment, anionic surfactants include mid-chain-branched anionic surfactants described in U.S. Pat. Nos. 6,320,080; 6,433,207; 6,326,348; 6,133,222; 6,012,781; 6,166,262; and 6,020,303.

In still another embodiment, the suitable nonionic surfactants comprise nitrogen containing materials selected from the group consisting of primary, secondary and tertiary amines, diamines, triamines, ethoxylated amines, amine oxides, amides and alkyl betaines, sulfobetaines, and mixtures thereof. Suitable amine oxide surfactants may include C10-C18 alkyl dimethyl amine oxides, C8-C12 alkoxy ethyl dihydroxy ethyl amine oxides, propyl amine oxides, and mixtures thereof. A nonlimiting example of a betaines is Schercotaine materials commercially available from Scher Chemicals. Other suitable nonionic surfactants of this class are generally disclosed in U.S. Pat. No. 3,929,678, issued to Laughlin et al., on Dec. 30, 1975; U.S. Pat. Nos. 5,230,835, issued to Deguchi et al., on Jul. 27, 1993; and PCT Publication WO 98/28393, by Ofosu-Asante et al., published on Jul. 2, 1998.

These and other surfactants suitable for use in combination with the fluorine-containing solvent as adjuncts are well known in the art, being described in more detail in Kirk Othmer's “Encyclopedia of Chemical Technology”, 3rd Ed., Vol. 22, pp. 360-379, which is titled “Surfactants and Detersive Systems”.

The surfactant component, when present in the fabric article treating compositions of the present invention, preferably comprises from about 0.01% to about 10%, more preferably from about 0.02% to about 5%, even more preferably from about 0.05% to about 2% by weight of the fabric article treating composition.

The surfactant component, when present in the detergent compositions of the present invention, preferably comprises from about 1% to about 99%, more preferably 2% to about 75%, even more preferably from about 5% to about 60% by weight of the detergent composition.

(ii) Softeners

In some embodiments, the adjunct ingredients may be cationic materials, such as fabric softening actives. Suitable cationic materials may include quaternary surfactants, which maybe quaternary ammonium compounds. Commercially available agents include Varisoft® materials from Goldschmidt.

Nonlimiting examples of suitable fabric softening actives include, but are not limited to: diester quaternary ammonium fabric softening active compounds (DEQA) and polyquaternary ammonium compounds.

(1) The first type of DEQA preferably comprises, as the principal active, compounds of the formula:

### [R₄₋ₘ—N⁺—[(CH₂)ₙ—Y—R¹]ₘ]A⁻

wherein each R substituent is selected from hydrogen; a short chain C₁-C₆ alkyl or hydroxyalkyl, preferably methyl, ethyl, propyl, or hydroxyethyl, and more preferably methyl; poly(C₁-C₃ alkoxy), preferably polyethoxy; benzyl; or a mixture thereof; each m is 2 or 3; each n is from 1 to about 4; each Y is —O—(O)C—, —C(O)—O—, —NR—C(O)—, or —C(O)—NR—; the sum of carbons in each R¹, plus one when Y is —O—(O)C— or —NR—C(O)—, is C₁₂-C₂₂, preferably C₁₄-C₂₀, with each R¹ being a hydrocarbyl, or substituted hydrocarbyl group, and A⁻ can be any softener-compatible anion, preferably, chloride, bromide, methylsulfate, ethylsulfate, sulfate, and nitrate, more preferably chloride or methyl sulfate. (As used herein, the “percent of softening active” containing a given R¹ group is based upon taking a percentage of the total active based upon the percentage that the given R¹ group is, of the total R¹ groups present.).

(2) A second type of DEQA active has the general formula:

[R₃N⁺CH₂CH(YR¹)(CH₂YR¹)]A⁻

wherein each Y, R, R¹, and A⁻ have the same meanings as before. Such compounds include those having the formula:

[CH₃]₃N⁽⁺⁾[CH₂CH(CH₂O(O)CR¹)O(O)CR ¹]Cl⁽⁻⁾

where each R is a methyl or ethyl group and preferably each R¹ is in the range of C₁₅ to C₁₉.

(3) The DEQA actives described hereinabove also include the neutralized amine softening actives wherein at least one R group is a hydrogen atom. A non-limiting example of actives of this type is the chloride salt of (unsaturated alkoyloxyethyl)(unsaturated alkylamidotrimethylene) methylamine. Other examples of suitable amine softening actives are disclosed in PCT application WO 99/06509.

(4) Polyquaternary Ammonium Softening Actives. Fabric softening actives carrying more than one positive quaternary ammonium charge are also useful in the rinse-added compositions of the present invention. An example of this type of softening active is that having the formula:

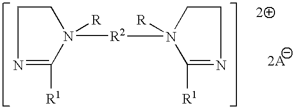

wherein each R is H, a short chain C₁-C₆ alkyl or hydroxyalkyl, preferably methyl, ethyl, propyl, or hydroxyethyl, and the like, more preferably methyl, benzyl, or (R²O)₂₋₄H; each R¹ is a C₆-C₂₂, preferably C₁₄-C₂₀ hydrocarbyl, or substituted hydrocarbyl substituent, preferably C₁₀-C₂₀ alkyl or alkenyl (unsaturated alkyl, including polyunsaturated alkyl, also referred to sometimes as alkylene”), most preferably C₁₂-C₁₈ alkyl or alkenyl; each R is a C₁-C₆ alkylene group, preferably an ethylene group; and A- are defined as below.

(5) Softening active having the formula:

[R₄₋ₘ—N⁺—R¹ₘ]A⁻

wherein each m is 2 or 3, each R¹ is a linear or branched, saturated or unsaturated C₆-C₂₂ moiety, preferably C₁₄-C₂₀ moiety, but no more than one being less than about C₁₂ and then the other is at least about C₁₆; or hydrocarbyl or substituted hydrocarbyl substituent, preferably C₁₀-C₂₀ alkyl or alkenyl, most preferably C₁₂-C₁₈ alkyl or alkenyl.

Examples of Compound (5) are dialkylenedimethylammonium salts, such as commercially available dialkylenedimethylammonium salts usable in the present invention is dioleyldimethylammonium chloride available from Witco Corporation under the trade name Adogen® 472.

Other examples of Compound (5) are the monoalkenyltrimethylarnmonium salts such as monooleyltrimethylammonium chloride, monocanolatrimethylammonium chloride, and soyatrimethylammonium chloride. Monooleyltrimethylammonium chloride and monocanolatrimethylammonium chloride are preferred.

(6) Softening active having the formula:

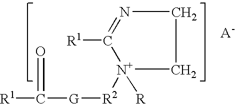

wherein each R, R¹, and A⁻ have the definitions given above; each R² is a C₁-C₆ alkylene group, preferably an ethylene group; and G is an oxygen atom or an —NR— group.

An example of Compound (6) is 1-methyl-1-oleylamidoethyl-2-oleylimidazolinium methylsulfate, which is available commercially from the Witco Corporation under the trade name Varisoft® 3690.

Other examples of Compound (6) are substituted imidazolinium salts having the formula:

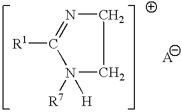

wherein R⁷ is hydrogen or a C₁-C₄ saturated alkyl or hydroxyalkyl group, and R¹ and A⁻ are defined as hereinabove.

(7) Softening active having the formula:

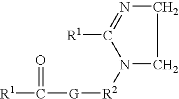

wherein R¹, R² and G are defined as above in (6).

(8) Reaction products of substantially unsaturated and/or branched chain higher fatty acids with dialkylenetriamines in, e.g., a molecular ratio of about 2:1, said reaction products containing compounds of the formula:

R¹—C(O)—NH—R²—NH—R³—NH—C(O)—R¹

wherein R¹, R² are defined as above in (6), and each R³ is a C₁-C₆ alkylene group, preferably an ethylene group. Examples of Compound (8) include Emersol® 223LL and Emersol® 7021, which are available from Henkel Corporation.

(9) Softening active having the formula:

[R¹—C(O)—NR—R²—N(R)₂—R³—NR—C(O)—R¹]⁺A⁻

wherein R, R¹, R², R³ and A⁻ are defined as above in (6) and (8). An example of Compound (9) is a difatty amidoamine based softening active available commercially from the Witco Corporation under the trade name Varisoft® 222LT.

(10) The reaction product of substantially unsaturated and/or branched chain higher fatty acid with hydroxyalkylalkylenediamines in a molecular ratio of about 2:1, said reaction products containing compounds of the formula:

R¹—C(O)—NH—R²—N(R³OH)—C(O)—R¹

wherein R¹, R² and R³ are defined as above in (8). Examples of Compound (10) include reaction products of oleic acids with N-2-hydroxyethylethylenediamine in a molecular ratio of about 2:1, said reaction product mixture containing a compound of the formula:

R¹—C(O)—NH—CH₂CH₂—N(CH₂CH₂OH)—C(O)—R¹

wherein R¹—C(O) is oleoyl group of a commercially available oleic acid derived from a vegetable or animal source, such as Emersol® 223LL or Emersol® 7021, available from Henkel Corporation.

(11) Alkylpyridinium salts having the formula:

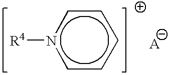

wherein R⁴ is an acyclic aliphatic C₈-C₂₂ hydrocarbon group and A⁻ is an anion.

(12) Alkanamide alkylene pyridinium salts having the formula:

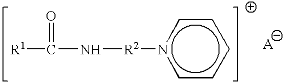

wherein R¹, R² and A⁻ are defined as herein above;

(13) Monoalkyl diquaternary salts, e.g., that having the formula:

A⁻[R¹—N⁽⁺⁾(R)₂—R²N⁽⁺⁾(R)₃]A⁻

wherein R, R¹, R² and A⁻ are defined as herein above in (6) and (9).

An example of Compound (13) is N-tallow pentamethyl propane diammonium dichloride, with the formula:

Cl⁻[(tallowalkyl)-N⁽⁺⁾(CH₃)₂—CH₂—CH₂—N⁽⁺⁾(CH₃)₃]Cl⁻

available from Witco Corporation under the trade name Adogen® 477.

(14) Mixtures of compounds (1)-(13) disclosed above.

In the cationic nitrogenous salts herein, the anion A⁻, which is any softening active compatible anion, provides electrical neutrality. Most often, the anion used to provide electrical neutrality in these salts is from a strong acid, especially a halide, such as chloride, methylsulfate, bromide, or iodide. However, other anions can be used, such as ethylsulfate, acetate, formate, sulfate, carbonate, and the like. Chloride and methylsulfate are preferred herein as anion A⁻.

The typical cationic fabric softening compounds include the water-insoluble quaternary-ammonium fabric softening actives, the most commonly used having been di(long alkylchain)dimethylammonium (C1-C4 alkyl)sulfate or chloride, preferably the methyl sulfate. Nonlimiting examples of these fabric softening compounds include the following:

1) di(tallowalkyl)dimethylammonium methyl sulfate (DTDMAMS);

2) di(hydrogenated tallowalkyl)dimethylammonium methyl sulfate;

3) di(hydrogenated tallowalkyl)dimethylammonium chloride (DTDMAC);

4) distearyldimethylammonium methyl sulfate;

5) dioleyldimethylammonium methyl sulfate;

6) dipalmitylhydroxyethylmethylammonium methyl sulfate;

7) stearylbenzyldimethylammonium methyl sulfate;

8) tallowalkyltrimethylammonium methyl sulfate;

9) (hydrogenated tallowalkyl)trimethylammonium methyl sulfate;

10) (C₁₂₋₁₄ alkyl)hydroxyethyldimethylammonium methyl sulfate;

11) (C₁₂₋₁₈ alkyl)di(hydroxyethyl)methylammonium methyl sulfate;

12) di(stearoyloxyethyl)dimethylammonium chloride;

13) di(tallowoyloxyethyl)dimethylammonium methyl sulfate;

14) ditallowalkylimidazolinium methyl sulfate;

15) 1-(2-tallowylamidoethyl)-2-tallowylimidazolinium methyl sulfate; and

16) mixtures thereof.

(iii) Other Additives

Suitable odor control agents, which may optionally be used as finishing agents, include cyclodextrins, odor neutralizers, odor blockers and mixtures thereof. Suitable odor neutralizers include aldehydes, flavanoids, metallic salts, water-soluble polymers, zeolites, activated carbon and mixtures thereof.

Perfumes and perfumery ingredients useful in the compositions of the present invention comprise a wide variety of natural and synthetic chemical ingredients, including, but not limited to, aldehydes, ketones, esters, and the like. Also included are various natural extracts and essences which can comprise complex mixtures of ingredients, such as orange oil, lemon oil, rose extract, lavender, musk, patchouli, balsamic essence, sandalwood oil, pine oil, cedar, and the like. Finished perfumes may comprise extremely complex mixtures of such ingredients. Pro-perfumes are also useful in the present invention. Pro-perfumes comprise precursor materials or mixtures thereof that are capable of chemically reacting (e.g., by hydrolysis) to release a perfume, and are described in patents and/or published patent applications to Procter and Gamble, Firmenich, Givaudan and others. Examples of perfume and perfume release/delivery vehicles are disclosed in U.S. Pat. No. 6,458,754; U.S. Pat. No. 5,858,959; U.S. Pat. No. 5,552,378; U.S. Pat. No. 6,413,920; U.S. Pat. No. 6,149,375; U.S. patent application Ser. No. 60/423,107; WO 03/002699; WO 99/36469; WO 00/68352; WO 98/28398; WO 98/28339; WO 01/79303 and EP 925,776.

Bleaches, especially oxygen bleaches, are another type of adjunct ingredient suitable for use in the compositions of the present invention. This is especially the case for the activated and catalyzed forms with such bleach activators as nonanoyloxybenzenesulfonate and/or any of its linear or branched higher or lower homologs, and/or tetraacetylethylenediamine and/or any of its derivatives or derivatives of phthaloylimidoperoxycaproic acid (PAP) or other imido- or amido-substituted bleach activators including the lactam types, or more generally any mixture of hydrophilic and/or hydrophobic bleach activators (especially acyl derivatives including those of the C₆-C₁₆ substituted oxybenzenesulfonates).

Also suitable are organic or inorganic peracids both including PAP and other than PAP. Suitable organic or inorganic peracids for use herein include, but are not limited to: percarboxylic acids and salts; percarbonic acids and salts; perimidic acids and salts; peroxymonosulfuric acids and salts; persulphates such as monopersulfate; peroxyacids such as diperoxydodecandioic acid (DPDA); magnesium peroxyphthalic acid; perlauric acid; perbenzoic and alkylperbenzoic acids; and mixtures thereof.

One class of suitable organic peroxycarboxylic acids has the general formula:

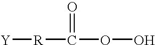

wherein R is an alkylene or substituted alkylene group containing from 1 to about 22 carbon atoms or a phenylene or substituted phenylene group, and Y is hydrogen, halogen, alkyl, aryl, —C(O)OH or —C(O)OOH.

Particularly preferred peracid compounds are those having the formula:

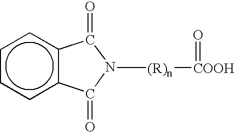

wherein R is C₁₋₄ alkyl and n is an integer of from 1 to 5. A particularly preferred peracid has the formula where R is CH₂ and n is 5 i.e., phthaloylamino peroxy caproic acid (PAP) as described in U.S. Pat. Nos. 5,487,818, 5,310,934, 5,246,620, 5,279,757 and 5,132,431. PAP is available from Ausimont under the tradename Euroco®.

Other adjunct ingredients suitable for use in the compositions of the present invention include, but are not limited to, builders including the insoluble types such as zeolites including zeolites A, P and the so-called maximum aluminum P as well as the soluble types such as the phosphates and polyphosphates, any of the hydrous, water-soluble or water-insoluble silicates, 2,2′-oxydisuccinates, tartrate succinates, glycolates, NTA and many other ethercarboxylates or citrates; chelants including EDTA, S,S′-EDDS, DTPA and phosphonates; water-soluble polymers, copolymers and terpolymers; soil release polymers; optical brighteners; processing aids such as crisping agents and/fillers; anti-redeposition agents; hydrotropes, such as sodium, or calcium cumene sulfonate, potassium napthalenesulfonate, or the like, humectant; other perfumes or pro-perfumes; dyes; photobleaches; thickeners; simple salts; alkalis such as those based on sodium or potassium including the hydroxides, carbonates, bicarbonates and sulfates and the like; and combinations of one or more of these adjunct ingredients.

Suitable finishing aids include, but are not limited to, finishing polymers; such as synthetic or natural polyacrylates or starch carboxymethyl cellulose or hydroxypropyl methyl cellulose, odor control agents, odor neutralizers, perfumes, properfumes, anti-static agents, fabric softeners, insect and/or moth repelling agents and mixtures thereof.

The finishing polymers can be natural, or synthetic, and can act by forming a film, and/or by providing adhesive properties to adhere the finishing polymers to the fabrics. By way of example, the compositions of the present invention can optionally use film-forming and/or adhesive polymer to impart shape retention to fabric, particularly clothing. By “adhesive” it is meant that when applied as a solution or a dispersion to a fiber surface and dried, the polymer can attach to the surface. The polymer can form a film on the surface, or when residing between two fibers and in contact with the two fibers, it can bond the two fibers together.

Nonlimiting examples of finishing polymers that are commercially available are: polyvinylpyrrolidone/dimethylaminoethyl methacrylate copolymer, such as Copolymer 958®, molecular weight of about 100,000 and Copolymer 937®, molecular weight of about 1,000,000, available from GAF Chemicals Corporation; adipic acid/dimethylaminohydroxypropyl diethylenetriamine copolymer, such as Cartaretin F-4® and F-23, available from Sandoz Chemicals Corporation; methacryloyl ethyl betaine/methacrylates copolymer, such as Diaformer Z-SM®, available from Mitsubishi Chemicals Corporation; polyvinyl alcohol copolymer resin, such as Vinex 2019®, available from Air Products and Chemicals or Moweol®, available from Clariant; adipic acid/epoxypropyl diethylenetriamine copolymer, such as Delsette 101®, available from Hercules Incorporated; polyamine resins, such as Cypro 515®, available from Cytec Industries; polyquaternary amine resins, such as Kymene 557H®, available from Hercules Incorporated; and polyvinylpyrrolidone/acrylic acid, such as Sokalan EG 310®, available from BASF.

Suitable adjuncts may also comprise co-surfactants, such as primary alkylamines comprising from about 6 to about 22 carbon atoms are used. Particularly preferred primary alkylamines are oleylamine (commercially available from Akzo under the tradename Armeen® OLD), dodecylamine (commercially available from Akzo under the tradename Armeen® 12D), branched C₁₆-C₂₂ alkylamine (commercially available from Rohm & Haas under the tradename Primene®), and mixtures thereof.

The adjunct ingredient may also be an antistatic agent. Any suitable well-known antistatic agents used in conventional laundering and dry cleaning are suitable for use in the compositions and methods of the present invention. Especially suitable as antistatic agents are the subset of fabric softeners which are known to provide antistatic benefits. For example those fabric softeners that have a fatty acyl group which has an iodine value of above 20, such as N,N-di(tallowoyl-oxy-ethyl)-N,N-dimethyl ammonium methylsulfate. However, it is to be understood that the term antistatic agent is not to be limited to just this subset of fabric softeners and includes all antistatic agents.

Preferred insect and moth repellent adjunct ingredients useful in the compositions of the present invention are perfume ingredients, such as citronellol, citronellal, citral, linalool, cedar extract, geranium oil, sandalwood oil, 2-(diethylphenoxy)ethanol, 1-dodecene, etc. Other examples of insect and/or moth repellents useful in the compositions of the present invention are disclosed in U.S. Pat. Nos. 4,449,987; 4,693,890; 4,696,676; 4,933,371; 5,030,660; 5,196,200; and in “Semio Activity of Flavor and Fragrance Molecules on Various Insect Species”, B. D. Mookherjee et al., published in Bioactive Volatile Compounds from Plants, ACS Symposium Series 525, R. Teranishi, R. G. Buttery, and H. Sugisawa, 1993, pp. 35-48.

Method

The present invention includes a method for treating fabric articles. Such method includes the step of contacting the fabric articles with a composition comprising one or more fluorine-containing solvents, and optionally, a polar solvent and/or additives. The method may optionally comprise a rinsing step and/or a pre-treating step, in addition to the contacting step. During the contacting step, the weight ratio of composition applied to the fabric article to the dry weight of the fabric article may range from 0.5:1 to 30:1, preferably from about 0.8:1 to about 5:1, more preferably from about 1:1 to about 1.5:1. In other words, the method may be non-immersive as well as immersive. The fabric article may be mechanically agitated, tumbled or otherwise moved in a treatment chamber to achieve uniform application of the composition to the fabric articles being treated.

The composition of the present invention can be prepared by mixing the ingredients by any known process chosen by the formulator. The mixing may even be performed by the user by shaking or other known mixing methods. In another embodiment, the fabric article may be exposed to the fluorine-containing solvent and the polar solvents and/or addtives that are not combined into a composition. For example, the fluorine-containing solvent, the polar solvent and the additives may be applied to the fabric article via different feed streams, thus, the fabric article being treated may come into contact with these materials simultaneously or sequentially.

Cleaning System and Apparatus

A cleaning system and apparatus suitable for use with the fluorine-containing solvents, the compositions or method employing the same are described below. The cleaning system comprises a fabric article treating vessel, a dry cleaning solvent reservoir, and optionally, a sensor for monitoring the contaminant level in the dry cleaning solvent. When contaminants concentration exceeds some pre-determined value, it would indicate that the dry cleaning solvent has reached maximum contaminant holding tolerance and needs to be purified. Additionally, solvent purification/recovery device comprising a chemical modification unit capable of conducting the purification method of the present invention may also be provided as an integral part of the system/apparatus. However, it needs not be. The solvent purification/recovery unit can be a stand-alone device, separate from the dry cleaning system.

Any suitable fabric article treating vessel known to those of ordinary skill in the art can be used. The fabric article treating vessel receives and retains a fabric article to be treated during the operation of the cleaning system. In other words, the fabric article treating vessel retains the fabric article while the fabric article is being contacted by the dry cleaning solvent. Nonlimiting examples of suitable fabric article treating vessels include commercial cleaning machines, domestic, in-home, washing machines, and clothes drying machines.

The methods and systems of the present invention may be used in a service, such as a cleaning service, diaper service, uniform cleaning service, or commercial business, such as a Laundromat, dry cleaner, linen service which is part of a hotel, restaurant, convention center, airport, cruise ship, port facility, casino, or may be used in the home.

The methods of the present invention may be performed in an apparatus that is a modified existing apparatus and is retrofitted in such a manner as to conduct the method of the present invention in addition to related methods.

The methods of the present invention may also be performed in an apparatus that is specifically built for conducting the present invention and related methods.

Further, the methods of the present invention may be added to another apparatus as part of a dry cleaning solvent processing system. This would include all the associated plumbing, such as connection to a chemical and water supply, and sewerage for waste wash fluids.

The methods of the present invention may also be performed in an apparatus capable of “dual mode” functions. A “dual mode” apparatus is one capable of both washing and drying fabrics within the same vessel (i.e., drum). These apparatuses are commercially available, particularly in Europe. Additionally, the method of the present invention may also be performed in an apparatus capable of performing “bi-modal” cleaning functions. A “bi-modal” apparatus is one capable of performing both non-aqueous washing and aqueous washing in the same vessel, wherein the two washing modes can be performed in sequential washing cycles or in a combination washing cycle. Additionally, the bi-modal machine is capable of fully drying the clothes without having to transfer them to a separate machine. That is, a machine can have the bi-modal function as well as the dual-mode function.

An apparatus suitable for use in the present invention will typically contain some type of control systems, including electrical systems, such as “smart control systems”, as well as more traditional electromechanical systems. The control systems would enable the user to select the size of the fabric load to be cleaned, the type of soiling, the extent of the soiling, the time for the cleaning cycle. Alternatively, the control systems provide for pre-set cleaning and/or refreshing cycles, or for controlling the length of the cycle, based on any number of ascertainable parameters the user programmed into the apparatus. For example, when the collection rate of dry cleaning solvent reaches a steady rate, the apparatus could turn its self off after a fixed period of time, or initiate another cycle for the dry cleaning solvent.

In the case of electrical control systems, one option is to make the control device a so-called “smart device”, which provides smart functions, such as self diagnostics; load type and cycle selection; Internet links, which allow the user to start the apparatus remotely, inform the user when the apparatus has cleaned a fabric article, or allow the supplier to remotely diagnose problems if the apparatus malfunctioned. Furthermore, if the system of the present invention is only a part of a cleaning system, the so called “smart system” could be communicating with the other cleaning devices which would be used to complete the remainder of the cleaning, such as a washing machine, and a dryer.

All documents cited in the Detailed Description of the Invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can made without departing from the spirit and scope of the invention. It is therefore intended to cover in the appended claims all such changes and modifications that are within the scope of this invention.

What is claimed is:

1. A fabric article treating composition comprising:
a fluorine-containing solvent having at least one of the following properties:
(i) an oil solvency as measured by KB value of greater than about 30;
(ii) non-flammable and has an oil solvency as measured by KB value of greater than about 9; or
(iii) a global warming potential of less than about 50; and
an adjunct ingredient.

2. The composition according to claim 1 wherein the fluorine-containing solvent further exhibits one or more of the following properties:
a) a density of greater than about 1.1 g/ml;
b) a boiling point of greater than about 35° C.;
c) mole percent of fluorine atoms is greater than mole percent of hydrogen atoms; and
d) a vapor pressure in the range of from about 0.3 mm Hg to about 30 mm Hg, as determined at 25° C.

3. The composition according to claim 1 wherein the solvent is selected from the group consisting of: fluoroamines, fluoroethers, fluoroalcohols, hydrofluoroethers, fluorosilicones and mixtures thereof.

4. The composition according to claim 1 wherein the solvent has the formula:
CF₃(CF₂)ₙOX or CF₃(CF₂)ₙNX′X
wherein n is an integer of from about 2 to about 20, and X, X′ contain at least one hydrogen.

5. The composition according to claim 4 wherein X, X′ are moieties that contain at least one hydrogen and at least one fluorine.

6. The composition according to claim 4 wherein X, X′ are independently selected from the group consisting of alkyl, alkylene, cycloalkyl, aryl, oxygen-containing group and mixtures thereof.

7. The composition according to claim 4 wherein at least one of X, X′ moieties is

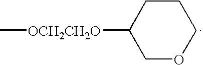

8. The composition according to claim 4 wherein at least one of X, X′ moieties is
—(CH₂)ₘO(CH₂)ₚCH₃
wherein m is from about 3 to about 20 and p is from about 2 to about 20.

9. The composition according to claim 1 wherein the solvent comprises at least one fluorine and at least one hydrogen, wherein the mole ratio of fluorine to hydrogen is in the range of from about 10:1 to about 1:10.

10. The composition according to claim 1 wherein the adjunct ingredient comprises a polar solvent.

11. The composition according to claim 10 wherein the polar solvent is selected from the group consisting of: water, alcohols, glycols, polyglycols, ethers, carbonates, dibasic esters, ketones, other oxygenated solvents, and mixtures thereof.

12. The composition according to claim 1 wherein the adjunct ingredient is an additive selected from the group consisting of: builders, surfactants, enzymes, bleach activators, bleach catalysts, bleach boosters, bleaches, alkalinity sources, antibacterial agents, colorants, perfumes, pro-perfumes, finishing aids, lime soap dispersants, odor control agents, odor neutralizers, polymeric dye transfer inhibiting agents, crystal growth inhibitors, photobleaches, heavy metal ion sequestrants, anti-tarnishing agents, anti-microbial agents, anti-oxidants, anti-redeposition agents, soil release polymers, electrolytes, pH modifiers, thickeners, abrasives, divalent or trivalent ions, metal ion salts, enzyme stabilizers, corrosion inhibitors, polyamines and/or their alkoxylates, suds stabilizing polymers, solvents, process aids, fabric softening agents, optical brighteners, hydrotropes, suds or foam suppressors, suds or foam boosters and mixtures thereof.

13. A method for treating a fabric article in need of treatment comprising the step of contacting the fabric article with a fabric article treating composition comprising a fluorine-containing solvent according to claim 1 such that the fabric article is treated.

14. The method according to claim 13 further comprising the step of contacting the fabric article with an adjunct ingredient selected from a polar solvent, an additive, and mixtures thereof.

15. The method according to claim 14 wherein the fabric article comes into contact with the fluorine-containing solvent and the adjunct ingredient simultaneously or sequentially.

16. A fabric article treated by the composition according to claim 1.

17. A fabric article treated by the method according to claim 15.

18. A fabric article treating composition comprising a fluorine-containing solvent having an oil solvency as measured by KB value of greater than about 30 and an adjunct ingredient.

19. A fabric article treating composition comprising a fluorine-containing solvent that is non-flammable and has an oil solvency as measured by KB value of greater than about 9 and an adjunct ingredient.

20. A fabric article treating composition comprising a fluorine-containing solvent having a global warming potential of less than about 50 and an adjunct ingredient.
